(19) United States
(12) Patent Application Publication
(10) Pub. No.: US 2014/0258525 A1
(43) Pub. Date: Sep. 11, 2014

(54) Computer Network Management Tools

(71) Applicant: Hangzhou H3C Technologies Co., Ltd., Hangzhou, Zhejiang (CN)

(72) Inventor: Qi Yang, Haidian District (CN)

(73) Assignee: Hangzhou H3C Technologies Co., Ltd.

(21) Appl. No.: 14/351,876

(22) PCT Filed: Dec. 11, 2012
(86) PCT No.: PCT/CN2012/086319

§ 371 Date: Apr. 14, 2014

(30) Foreign Application Priority Data
Dec. 12, 2011 (CN) 201110411119.4

(51) Int. Cl. H04L 12/26

(52) U.S. Cl. CPC H04L 43/02
USPC 709/224

(57) ABSTRACT

A network device for computer network operation includes a processor and a memory. A set of object identifiers (OID) and a set of device management identifiers are stored in the memory, wherein each object identifier is mapped to a corresponding device management parameter to facilitate management of the network device. The set of device management identifiers collective represents the set of object identifiers. The network device is to make available the device management identifiers and values corresponding to the device management parameters to facilitate network management.

### BACKGROUND

A computer network typically comprises many network devices which are managed by a network management system (NMS). Network devices managed by an NMS are also called managed devices. Network management tasks are typically categorized to include faults, configuration, accounting, performance, and security (FCAPS) management, and management functions generally include controlling, planning, allocating, deploying, coordinating, and monitoring the resources of a network, network planning, frequency allocation, predetermined traffic routing to support load balancing, cryptographic key distribution authorization, configuration management, fault management, security management, performance management, bandwidth management, route analytics and accounting management.

An NMS employs various protocols to accomplish these tasks. For example, the Simple Network Management Protocol (SNMP) protocol can be used to gather the information from network devices in the network and the remote monitoring (RMON) protocol can be used to support monitoring and protocol analysis.

As computer network grows, network management requirements become more complicated and improved network management tools are beneficial.

### DESCRIPTION OF FIGURES

The disclosure will be described by way of non-limiting examples with reference to the accompanying Figures, in which:

FIGS. 1 and 1A show example MIB trees,

FIG. 2 shows a computer network comprising a network management apparatus and a number of network devices, and

FIG. 3 shows a mapping between example MIB files and information representing the MIB files.

### DESCRIPTION OF EXAMPLES

A typical computer network comprises a number of network devices managed by a network management apparatus. The number can be one or any integer larger than one. A network management apparatus is also known as a network manager or a network administrator. A network device, such as router, switch, server, workstation, printers, UPS, usually requires some form of monitoring and management, and the network management apparatus is to perform such network monitoring and management tasks.

Simple Network Management Protocol (SNMP) is one of the most widely accepted protocols to manage network devices. SNMP is an application-layer protocol defined by the Internet Architecture Board (IAB) in RFC1157 for exchanging management information between network devices. It is a part of Transmission Control Protocol/Internet Protocol (TCP/IP) protocol suite. SNMP generally consists of SNMP manager, managed devices, SNMP agent, and Management Information Database (MIB).

SNMP manager is responsible for monitoring or managing a group of network devices, and to communicate with SNMP agent implemented network devices. The manager provides interface between a human operator and the management system, and is typically a computer that is used to run a network management system. A network device can be a host or non-host device which is attached to a computer network. A SNMP manager is an SNMP example of a network management apparatus.

A managed device operable in SNMP is a network device that implements an SNMP interface that allows unidirectional (read-only) or bidirectional access to device-specific information. Managed devices exchange node-specific information with the NMSs. Sometimes called network elements, the managed devices can be any type of device, such as routers, access servers, switches, bridges, hubs, IP telephones, IP video cameras, computer hosts, and printers. In general, managed devices are ones that can be monitored, controlled and are capable of reporting events.

The SNMP agent is usually a network-management software module that resides on a managed device and has local knowledge of management information. A SNMP agent translates management information to or from an SNMP specific form. Upon execution of the SNMP agent, management information will be reported to the SNMP manager via SNMP. In general, a SNMP agent exposes management data on the managed systems as variables. The SNMP protocol permits active management tasks, such as modifying and applying a new configuration through remote modification of these variables. The SNMP agent therefore provides interface between the SNMP manager and the network device(s) being managed.

The SNMP manager and the SNMP agent use Management Information Base (MIB) to exchange management information. The MIB is a collection (or virtual database) of information for management of network devices and comprises managed objects. To enable the SNMP manager or equivalent network management applications to operate intelligently on the data available on the managed device, the manager needs to know the names and types of objects in the device. This is made possible by MIB modules, which are specified in the MIB files or documents usually provided with the network devices.

The MIB is organized in a tree structure with individual variables represented as other words, each OID is organized hierarchically in MIB and the MIB hierarchy can leaves on branches and each entry is addressed through an object identifier (OID). A typical OID comprises a dotted list of integers.

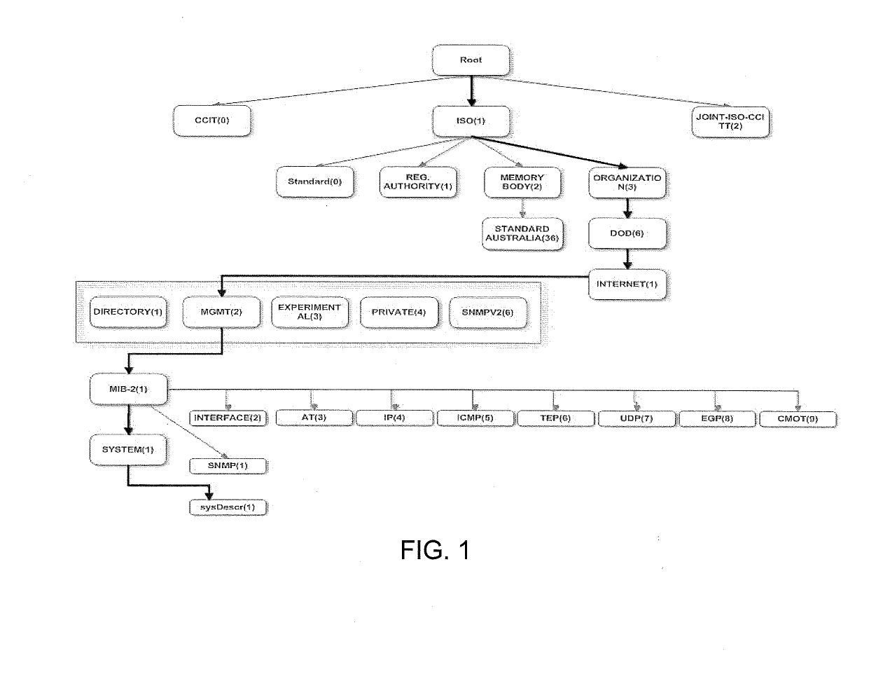

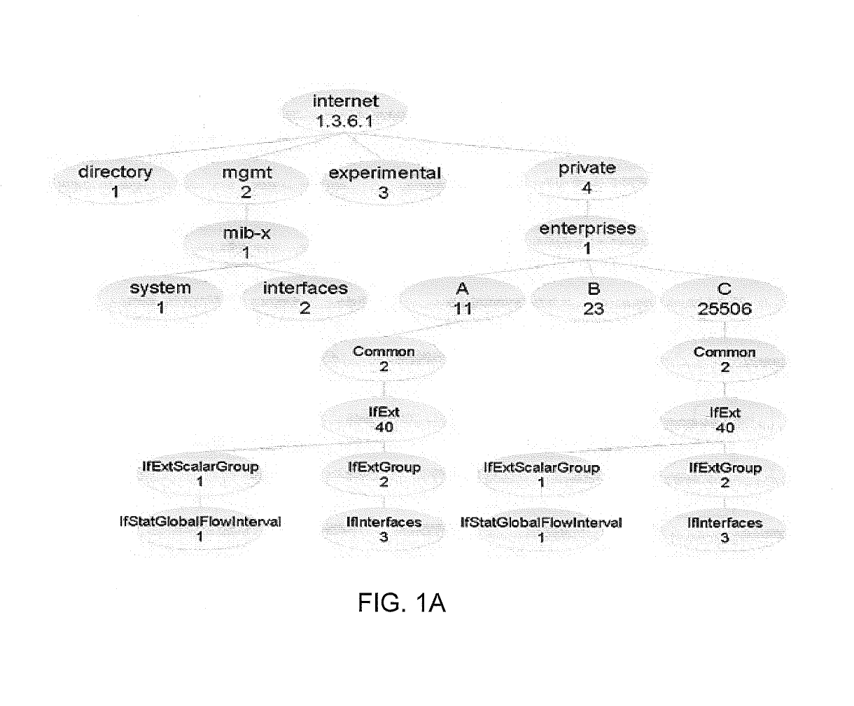

OIDs are arranged in a hierarchical inverted tree structure. As depicted in FIG. 1, the OID tree begins with the root and expands into branches. Each point in the OID tree is called a node and each node will have one or more branches, or will terminate with a leaf node. The format of OID is a sequence of numbers with dots in between. There are two roots for Object Identifiers, namely iso and ccit. iso starts with .1 and ccit starts with .0. Most Object Identifiers start with .1.3.6.1, where 1=iso, 3=org, 6=dod, 1=internet. The internet sub-tree branches into ‘mgmt’ and ‘private’. For example, the OID in RFC1213 for “sysDescr” is .1.3.6.1.2.1.1.1.

According to RFC 1155, an OID is a sequence of integers which traverse a global tree. The tree consists of a root connected to a number of labeled nodes via edges. Each node may, in turn, have children of its own which are labeled. In this case, we may term the node a sub-tree. This process may continue to an arbitrary level of depth. The root node itself is unlabeled, but has at least three children directly under it: one node is administered by the International Organization for Standardization, with label iso(1); another is administrated by the International Telegraph and Telephone Consultative Committee, with label ccitt(0); and the third is jointly administered by the ISO and the CCITT, joint-iso-ccitt(2).

Under the iso node(1), the ISO has designated one sub-tree for use by other national or international organizations, org(3). Of the children nodes present, two have been assigned to the U.S. National Institutes of Standards and Technology. One of these sub-trees is assigned to the U.S. Department of Defense, dod (6).

The higher level OID of FIG. 1 is as follows:

| | OBJECT IDENTIFIER |
|---|---|
| directory | {internet 1} |
| management | {internet 2} |
| experimental | {internet 3} |
| private | {internet 4} |
| mib, mib-1, mib-2, . . . | {mgmt 1} |
| enterprises | {private 1} |

The private (4) sub-tree is used to identify objects defined unilaterally. Administration of the private sub-tree is delegate by the IAB to the Internet Assigned Numbers Authority for the Internet, and this sub-tree has at least one child.

The enterprises (1) sub-tree is used to permit parties providing networking subsystems to register models of their products. Upon receiving a sub-tree, the private enterprise may, for example, define new MIB objects in this sub-tree. In addition, an enterprise may also register its networking subsystems under this sub-tree in order to provide an unambiguous identification mechanism for use in management protocols.

For example, if a private company “C” manufactured networking subsystems, company C could request a node under the enterprises sub-tree from the Internet Assigned Numbers Authority, company C may be assigned a node having the below OID:

.1.3.6.1.4.1.25506.

For example, an entry on the right-most branch of the tree of FIG. 1 of company C can be represented as a dotted list of integers as below:

.1.3.6.1.4.1.25506.2.40.2.3.1

The same entry can be represented by a dotted textual string as below:

.iso.org.dod.internet.private.enterprises.C.Common.IfExt.hh3clfExtGroup.IfInterfaces.If PhysicalNumber

In the above dotted textual string, C is the code assigned to company C (25506), and the dotted data on the right side of the company code are internal company parameters.

MIB defines managed objects using a framework called the structure of management information (SMI). SMI defines how management information is grouped and named; allowed operations; permitted data types; and the syntax for specifying MIB. Objects for standard SNMP MIBs are defined under the “mib” branch of the hierarchy of FIG. 1. MIB is defined by a collection of module definitions which may be contained in one or more documents. Each MIB module has a specific definitive document which is called a MIB file. It should be understood that MIB is only an abstraction of data and not a physical database or a physically executable object.

It will be noted that the internet sub-tree branches into “mgmt” and “private”. All the standard MIBs are under “mgmt”, while the private MIBs are under the “private.enterprises” sub tree. The standard MIBs are those that have been approved by the IAB. Equipment and software vendors define the private MIBs unilaterally. A branch within the “private.enterprises” sub-tree is allocated to each vendor who registers for an enterprise Object Identifier. The distinction between the standard and private MIBs is based on how the variables are defined. RFC1213-MIB (also known as MIB-II) is an example of a standard MIB. It is a MIB module which is typically supported by all SNMP agents on TCP/IP-enabled devices or systems. This MIB file contains a description of the object hierarchy on the managed device, as well as the Object ID, syntax, and access privileges for each variable in the MIB.

When specifying an object to the SNMP agent, a proper OID, which includes the instance, needs to be used by the SNMP manager. When not properly specified, the agent responds with a “No such variable” error.

However, the MIB resident or operational in a network device may be different to the MIB used by the network management apparatus to perform network management functions on the network device. For example, new versions of MIB with new functionality or new parameters may have been loaded to a network device, while a non-compatible or an obsolete version of MIB may be used by the network management apparatus. On the other hand, a MIB may already be available to the network management apparatus but this may not be known on the network management apparatus. For example, when a network device manufactured by company C having an assigned enterprise or vendor code of 25506 is supplied as an OEM (original equipment manufacturer equipment) of company A under a different vendor identity code 11, the MIBs will be the same but the OID representing the MIB of company A will differ from the OID representing the MIB of company C by a single code. For example, the OID of a MIB of vendor C for a network device may be [1.3.6.1.4.1.25506.2.40.2.3.1] while the OID of the same MIB for the same network device when supplied under company A will become [1.3.6.1.4.1.11.2.40.2.3.1] because the MIB will be collected under MIBs of company A as depicted in FIG. 1A.

When network devices are managed using conventional network management methodologies, the network management apparatus would need to go through tedious procedures in order to properly perform its network management functions. For example, when there are changes in the version of a specific MIB which is resident in a network device, the network management apparatus would need to traverse each branch of the MIB tree stored in the apparatus in a trial-and-error in order to identify a correct MIB for processing information received from the network device. Likewise, the network management apparatus is required to traverse the MIB tree to find a correct MIB for an OEM device while a correct MIB is already known present, albeit under the OID having a different vendor identity.

The present disclosure discloses a network management apparatus comprising a processor and a memory for managing a number of network devices on a computer network, wherein the processor is to communicate with a network device on the computer network to collect a set of device management identifiers and values corresponding to device management parameters relating to the network device to facilitate network management; wherein the set of device management identifiers provides a collective representation of a set of object identifiers and each object identifier in the set of object identifiers is mapped to a device management parameter; and wherein the apparatus is to process the values of the network device to facilitate network management by retrieving a set of object identifiers with reference to the set of device management identifiers.

The network apparatus would be able to process values obtained from a network device and useful for network management with reference to the set of device management identifiers. The set of device management identifiers may comprise a combination of vendor identification data and version number. In general, a device management identifier may comprise any information which can be used for the network management apparatus to correctly process the values. A device management identifier may contain information relating to, for example, vendor identification data, version number, date of release, date of upgrade, place of manufacture, factory identification, or other useful information without loss of generality.

There is also described a network device for computer network operation comprising a processor and a memory, wherein a set of object identifiers (OID) and a set of device management identifiers are stored in the memory, wherein each object identifier is mapped to a corresponding device management parameter to facilitate management of the network device, and the set of device management identifiers collective represents the set of object identifiers; and wherein the network device is to make available the device management identifiers and values corresponding to the device management parameters to facilitate network management.

Making the device management identifiers available to the network management apparatus means that the network management apparatus can use a correct processing application to process values of management significance obtained from the network device without going through the tedious routines when using conventional methodologies.

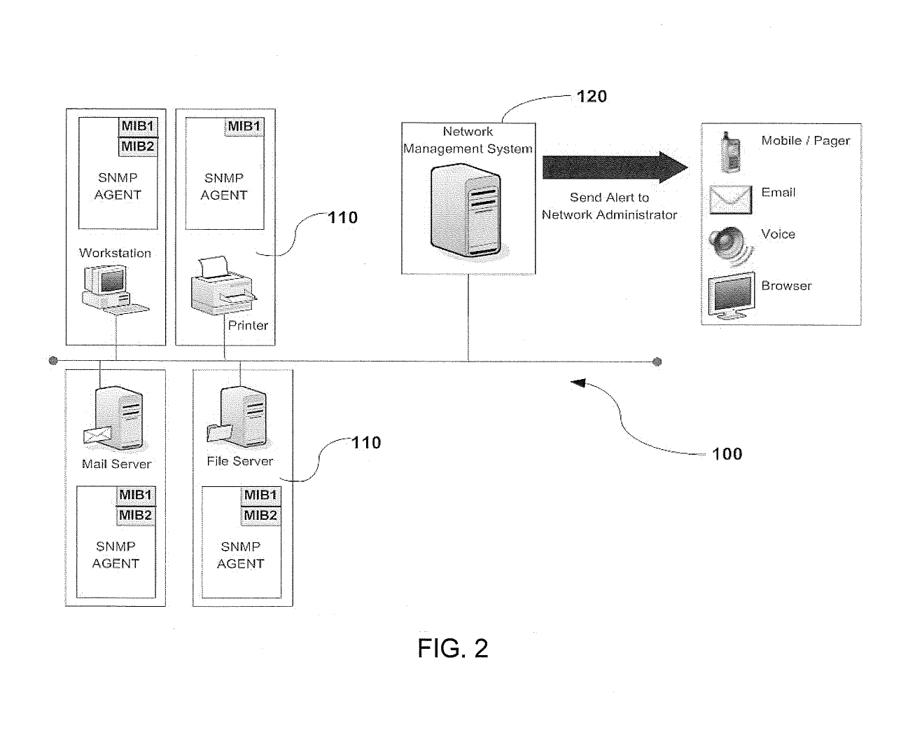

The network 100 depicted in FIG. 2 comprises a number of network devices 110 which are connected to a network managed by a network management apparatus 120. The network device may be a server, a workstation, a printer, a router, a switch or other known network manageable devices. Each network device comprises a processor and a memory with a SNMP agent installed and enabled. MIB modules are stored in the memory of the network device to facilitate network management by the network management apparatus. The network management apparatus comprises a processor and a memory and is configured to operate as a SNMP manager. MIB modules are stored in the memory of the network management apparatus to facilitate processing of variables obtained from the network devices. A typical MIB module is usually assigned for a specific network management function. For example, an IF-MIB module is for managing parameters at network interfaces, IF-EXT-MIB is an extension to IF-MIB, a QoS-MIB module is for managing QoS and a SYS-MIB module is for managing system administration parameters.

Assuming, solely as a convenient example, that an IF-EXT-MIB module of version C1.0 of a network device of company C which was released in year 2010 comprises the following variables:

IF-EXT-MIB C1.0

| OID | Object variable | Value units |
|---|---|---|
| .1.3.6.1.4.1.25506.2.40.2.3.1 | CPU usage | % |
| .1.3.6.1.4.1.25506.2.40.2.3.2 | Storage usage | % |
| .1.3.6.1.4.1.25506.2.40.2.3.3 | Storage size | MB |

This IF-EXT-MIB module was updated in 2011 to become a version C2.0 MIB as below:

IF-EXT-MIB C2.0

| OID | Object variable | Value units |
|---|---|---|
| .1.3.6.1.4.1.25506.2.40.2.3.1 | CPU usage | % |
| .1.3.6.1.4.1.25506.2.40.2.3.2 | Available storage | % |
| .1.3.6.1.4.1.25506.2.40.2.3.3 | Storage size | GB |
| .1.3.6.1.4.1.25506.2.40.2.3.4 | Bandwidth usage | % |

In this 2011 update version, the variable ‘storage usage’ under the OID was changed to ‘available storage’, although the same OID remains. In addition, the unit for storage size was changed to ‘GB’ from ‘MB’ and a new variable ‘bandwidth usage’ was added.

Assuming now that this network device is sold as an OEM product under vendor identity of company A, the IF-EXT-MIB module for the same network device will be assigned version A2.0 and have the following variable:

IF-EXT-MIB A2.0

| OID | Object variable | Value units |
|---|---|---|
| .1.3.6.1.4.1.11.2.40.2.3.1 | CPU usage | % |
| .1.3.6.1.4.1.11.2.40.2.3.2 | Available storage | % |
| .1.3.6.1.4.1.11.2.40.2.3.3 | Storage size | GB |
| .1.3.6.1.4.1.11.2.40.2.3.4 | Bandwidth usage | % |

It will be apparent from the above tables that the only difference between the version C2.0 of company C and version A2.0 MIB of company A above is the value of the node under the enterprise node (.1.3.6.1.4.1.) representing vendor identity. The object variables above are examples of device management parameters or device management variables which can be used by the network management apparatus to manage the network.

Each of the version numbers above, namely, C1.0, C2.0, & A2.0, comprises a vendor identification code or vendor identifier (A & C) which is unique to a vendor and a version number to distinguish between different releases of the same vendor. As the format of the version numbers contains a specific combination of information which is sufficient to identify a correct MIB module for use by the network management, the version numbers can be used as a set of device management identifiers by the network management to retrieve a correct MIB module to process values received from a network device without the need to “trial-and-error”. In this example, the vendor identification code, that is A or C, forms a device management identifier and the version number, that is 1.0 or 2.0 forms another device management identifier, and their combination forms a collective representation or definition of a set of device management identifiers which can be used as a pointer or name for the network management apparatus to locate the correct MIB module. The set of device management identifiers comprising a combination of the vendor identification or vendor identity and the version number is an example of a unique MIB identifier which can be used to expeditiously identify a correct MIB module or a correct MIB application module to process the values corresponding to the device management parameters or variables. In another aspect, the MIB identifier is an example identification corresponding to the set of object variables.

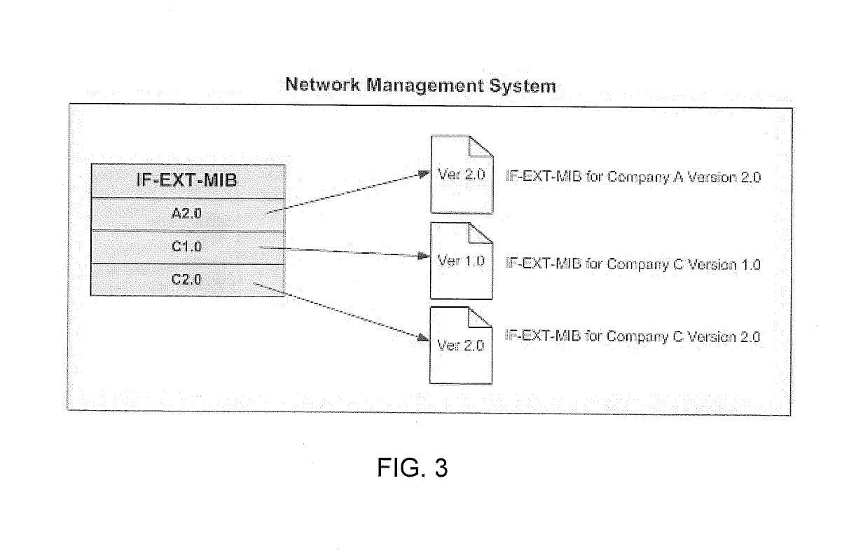

The network management apparatus maintains a mapping between the various sets of the device management identifiers and their corresponding management documents to expedite proper processing of the values obtained from the network device. In this example, a mapping providing a one-to-one linking between the version names, C1.0, C2.0, & A2.0, and the three sets of IF-EXT-MIB modules above is maintained in the network management apparatus as depicted in FIG. 3.

To facilitate utilization of the mapping by the network management apparatus, a new MIB module is stored in the network device. This MIB module is assigned a module name ADAPT-MIB as a convenient example and contains the following variables:

| OID | Object variable |
|---|---|
| .1.3.6.1.2.1.12.1 | Module name |
| .1.3.6.1.2.1.12.2 | Version information |

In operation, the network management apparatus as a SNMP manager will send a ‘GetRequest’ to the SNMP agent of a network device and the SNMP agent will return the Module Name and version information as follows:

| OID | Object variable |
|---|---|
| .1.3.6.1.2.1.12.1 | IF-EXT-MIB |
| .1.3.6.1.2.1.12.2 | C2.0 |

Upon receiving the response from the network device, the network management apparatus will be able to retrieve the correct MIB module or the correct MIB application module with reference to the mapping to correctly process values of the various device management parameters.

For example, if conventional network methodologies are used, a network management apparatus equipped with the version C1.0 IF-EXT-MIB for managing a network device installed with a C2.0 IF-EXT-MIB will present the ‘Storage size’ parameter in units of ‘MB’ while the actual values obtained by the SNMP agent is in units of ‘GB’. Similarly, a network management apparatus equipped with version C2.0 IF-EXT-MIB when managing a network device installed with A2.0 ID-EXT-MIB will not be able to process the ‘bandwidth usage’ parameter. The aforesaid problems will be alleviated when methodologies disclosed herein in are applied.

While a computer network comprising a SNMP manager and SNMP agents have been described above, it should be understood that the example is non-limiting and is used for convenience only since SNMP is the most widely used protocol for computer network management. In the above example, while the ADAPT-MIB includes objects having OIDs in the standard MIB branch node [.1.3.6.1.2.1], it should be appreciated that the MIB can also be under the enterprise or other branches without loss of generality.

1. A network device for computer network operation comprising a processor and a memory, wherein a set of object identifiers (OID) and a set of device management identifiers are stored in the memory, wherein each object identifier is mapped to a corresponding device management parameter to facilitate management of the network device, and the set of device management identifiers collective represents the set of object identifiers; and wherein the network device is to make available the device management identifiers and values corresponding to the device management parameters to facilitate network management.

2. The network device according to claim 1, wherein the set of device management identifiers comprises information relating to vendor identity of the network device, or information relating to version identity of the set of object identifiers, or information relating to a combination of vendor identity or version identity of the set of object identifiers.

3. The network device according to claim 2, wherein the set of object identifiers is collectively identifiable by an identifier such as a file name or a module name, and the set of device management identifiers comprises information containing the identifier.

4. The network device according to claim 1, wherein the network device is a SNMP managed device and the processor is to operate as a SNMP agent to collect values corresponding to the device management parameters, and the set of object identifiers is stored as management information base (MIB) designated by a file name with MIB designation.

5. The network device according to claim 4, wherein the set of device management identifiers is stored in the memory as management information base (MIB).

6. The network device according to claim 5, wherein each object identifier is represented by a dotted list of integers defined using Abstract Syntax Notation One (ASN.1).

7. A network management apparatus comprising a processor and a memory for managing a number of network devices on a computer network, wherein the processor is to communicate with a network device on the computer network to collect a set of device management identifiers and values corresponding to device management parameters relating to the network device to facilitate network management; wherein the set of device management identifiers provides a collective representation of a set of object identifiers and each object identifier in the set of object identifiers is mapped to a device management parameter; and wherein the apparatus is to process the values of the network device to facilitate network management by retrieving a set of object identifiers with reference to the set of device management identifiers.

8. The network management apparatus according to claim 7, wherein the network management apparatus stores mapping information between the device management identifiers and the set of object identifiers in the memory.

9. A network management apparatus according to claim 8, wherein the set of device management identifiers comprises information relating to vendor identity of the network device, or information relating to version identity of the set of object identifiers, or information relating to a combination of vendor identity or version identity of the set of object identifiers.

10. The network management apparatus according to claim 7, wherein the set of object identifiers is collectively identifiable by an identifier such as a file name or a module name, and the set of device management identifiers comprises information containing the identifier.

11. The network management apparatus according to claim 7, wherein the network management apparatus is to operate as a SNMP network manager and the set of object identifiers is stored as management information base (MIB) designated by a file name with MIB designation.

12. The network management apparatus according to claim 11, wherein the network management apparatus is to request the network device to provide the set of device management identifiers and values corresponding to the device management parameters using SNMP commands.

13. The network management apparatus according to claim 7, wherein each object is represented by an object identifier, the object identifier comprising a dotted list of integers defined using Abstract Syntax Notation One (ASN.1).

14. A computer network comprising a network device and a network management apparatus; wherein the network device is for computer network operation and comprises a processor and a memory, wherein a set of object identifiers (OID) and a set of device management identifiers are stored in the memory, wherein each object identifier is mapped to a corresponding device management parameter to facilitate management of the network device, and the set of device management identifiers collective represents the set of object identifiers, and wherein the network device is to make available the device management identifiers and the values corresponding to the device management parameters for collection by the network management apparatus; and
wherein the network management apparatus comprises a processor and a memory for managing a number of network devices on a computer network, wherein the processor is to communicate with a network device on the computer network to collect a set of device management identifiers and values corresponding to device management parameters relating to the network device to facilitate network management; wherein the set of device management identifiers provides a collective representation of a set of object identifiers and each object identifier in the set of object identifiers is mapped to a device management parameter; and wherein the network management apparatus is to process the values using a set of object identifiers retrieved with reference to the set of device management identifiers obtained from the network device.

15. (canceled)
